(19) United States
(12) Patent Application Publication
(10) Pub. No.: US 2011/0182795 A1
(43) Pub. Date: Jul. 28, 2011

(54) REDUCTION OF SILICA

(75) Inventor: Robert Lloyd, New South Wales (AU)

(73) Assignee: CBD Energy Limited, Double Bay (AU)

(21) Appl. No.: 12/918,106

(22) PCT Filed: Feb. 19, 2009
(86) PCT No.: PCT/AU2009/000192

§ 371 Date: Apr. 18, 2011

(30) Foreign Application Priority Data
Feb. 20, 2008 (DE) 10200810744.1

(51) Int. Cl. C01B 33/023; C01B 33/02; B01J 19/00

(52) U.S. Cl. 423/350; 423/348; 422/600

(57) ABSTRACT

A process for producing silicon comprising reacting silica with a reducing gas comprising carbon monoxide, wherein the reducing gas does not contain elemental carbon. A reactor for producing silicon comprising a carbon combustion chamber for reacting carbon with oxygen to generate a reducing gas comprising carbon monoxide, wherein the reducing gas contains no elemental carbon; a reaction chamber for reacting the reducing gas containing no elemental carbon with silica, the reaction chamber communicating with the carbon combustion chamber; a temperature controller for controlling the temperature of the reaction chamber; a silica inlet port communicating with the reaction chamber for admitting the silica to the reaction chamber; and a silicon outlet port communicating with the reaction chamber for allowing the silicon to leave the reaction chamber.

### TECHNICAL FIELD

The present invention relates to a process and reactor for reduction of silica to silicon.

### BACKGROUND

The semiconductor industry has an ongoing need for high purity silicon metal. Current processes for producing high purity silicon include reduction of silicon halides e.g. silicon tetrachloride or trichlorosilane, oxidation of silane and reduction of silica with elemental carbon or hydrogen. A disadvantage of several of these methods is the production of toxic or polluting by-products, which present problems of disposal and/or of separation from the product. Use of hydrogen as a reductant requires extreme care to exclude oxygen in order to avoid explosions.

### SUMMARY OF INVENTION

In a first aspect, the present invention provides a process for producing silicon comprising reacting silica with a reducing gas comprising carbon monoxide, wherein the reducing gas does not contain elemental carbon.

Preferably, the reducing gas is generated by reaction of elemental carbon with oxygen.

Preferably, the silica is reacted with the reducing gas within a heated reaction chamber.

Preferably, the temperature of the heated reaction chamber is controlled and the silica is reacted with the reducing gas at a temperature above the melting point of silicon.

Preferably, the silicon is degassed before it is allowed to solidify.

The exhaust gas from the process may be oxidised so as to convert substantially all carbon monoxide therein to carbon dioxide, thereby producing oxidised exhaust gas.

The oxidised exhaust gas can be used to preheat a raw material for the process.

Preferably, the silica is at least about 99.9% pure by weight.

In a second aspect, the present invention provides silicon produced by the process according to the first aspect of the present invention.

In a third aspect, the present invention provides a reactor for producing silicon comprising:

a carbon combustion chamber for reacting carbon with oxygen to generate a reducing gas comprising carbon monoxide, wherein the reducing gas contains no elemental carbon;

a reaction chamber for reacting the reducing gas containing no elemental carbon with silica, the reaction chamber communicating with the carbon combustion chamber;

a temperature controller for controlling the temperature of the reaction chamber;

a silica inlet port communicating with the reaction chamber for admitting the silica to the reaction chamber; and

a silicon outlet port communicating with the reaction chamber for allowing the silicon to leave the reaction chamber.

Preferably, the reactor further comprises a degasser for degassing the silicon after it has left the reaction chamber.

Preferably, the reactor further comprises a silica preheater for preheating the silica prior to the silica entering the reaction chamber.

Preferably, the reactor further comprises at least one preheater for preheating either the carbon or the oxygen or both the carbon and oxygen.

The reactor may contain pipework for passing exhaust gas from the reaction chamber, or oxidised exhaust gas obtained by oxidation of the exhaust gas, or both, to at least one of the preheaters for preheating at least one of the carbon, the oxygen and the silica.

The reactor may contain an exhaust gas combustion chamber for oxidising carbon monoxide in exhaust gas from the reaction chamber to carbon dioxide in order to generate oxidised exhaust gas.

Preferably, the reactor further comprises one or more flow controllers for controlling the flow of one or more of the carbon, the oxygen and the silica.

Preferably, the reaction chamber communicates thermally with a heat storage unit.

In a fourth aspect, the present invention provides a process for producing silicon, the process comprising:

providing a reactor, the reactor comprising a carbon combustion chamber for reacting carbon with oxygen to generate a reducing gas comprising carbon monoxide, the reducing gas containing no elemental carbon;

a reaction chamber for reacting the reducing gas containing no elemental carbon with silica, the reaction chamber communicating with the carbon combustion chamber; a temperature controller for controlling the temperature of the reaction chamber;

a silica inlet port communicating with the reaction chamber for admitting the silica to the reaction chamber; and a silicon outlet port communicating with the reaction chamber for allowing the silicon to leave the reaction chamber;

supplying oxygen and carbon to the carbon combustion chamber; reacting the carbon with the oxygen to generate a reducing gas comprising carbon monoxide, the reducing gas containing no elemental carbon;

supplying the reducing gas and the silica to the reaction chamber; and

reacting the reducing gas and the silica to produce the silicon and exhaust gas.

In a fifth aspect, the present invention provides use of a reactor according to the fourth aspect of the present invention to produce silicon.

The process may also comprise the step of generating the carbon monoxide by reaction of elemental carbon with oxygen. In this case, the ratio of carbon to oxygen may be such that no elemental carbon is present in the carbon monoxide. The ratio of carbon to oxygen should be such that all of the oxygen is consumed. The process may comprise removing elemental carbon from the reducing gas before the step of reacting the silica therewith. The reaction of the silica with the reducing gas generates silica, and converts the reducing gas to an exhaust gas.

Exhaust gas from the process may be used to preheat a raw material for the process prior to use thereof in the process. The exhaust gas from the process may be oxidised so as to convert substantially all of the carbon monoxide therein to carbon dioxide, thereby producing oxidised exhaust gas. The oxidised exhaust gas may be used to preheat a raw material for the process prior to use thereof in the process. In this way, heat energy generated in the process by oxidation processes, and/or heat inputted into the process, may be recycled in order to reduce or minimise the energy consumption of the process and/or to improve the energy efficiency of the process. Additionally, oxidation of the exhaust gas reduces its toxicity, rendering it more suitable for release to the atmosphere.

The step of reacting the silica with carbon monoxide may be conducted within a heated reaction chamber. The temperature of the heated reaction chamber may be controlled. It may be controlled to a temperature above the melting point of silicon. It may be controlled to a temperature below the boiling point of silicon. It may be controlled to a temperature between the melting point and the boiling point of silicon. The temperature of the heated reaction chamber may be between about 1400° C. and about 2300° C. The step of reacting the silica with carbon monoxide may be conducted at a temperature above the melting point of silicon. The silicon may be degassed before it is allowed to solidify.

An exhaust gas oxidation chamber may be provided for oxidising carbon monoxide in exhaust gas from the reaction chamber to carbon dioxide in order to generate oxidised exhaust gas. The reaction chamber may communicate with the exhaust gas oxidation chamber via the exhaust gas outlet port. Flow controllers may also be provided for controlling the flow of one or more of the carbon, the oxygen and the silica.

A heat storage unit may be provided, which communicates thermally with the reaction chamber.

Throughout this specification, unless the context requires otherwise, the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

Any discussion of documents, acts, materials, devices, articles or the like which has been included in the present specification is solely for the purpose of providing a context for the present invention. It is not to be taken as an admission that any or all of these matters form part of the prior art base or were common general knowledge in the field relevant to the present invention as it existed before the priority date of each claim of this specification.

In order that the present invention may be more clearly understood, preferred embodiments will be described with reference to the following drawing and examples.

### BRIEF DESCRIPTION OF THE DRAWINGS

FIG. 1 is a diagrammatic representation of the process of a reactor according to the present invention.

### MODE(S) FOR CARRYING OUT THE INVENTION

In the present specification, the term “silicon” will be taken to refer to elemental silicon, or silicon metal. It will be understood that the term “silicon metal” is commonly used, although elemental silicon may be regarded as being semi-metallic, and is sometimes referred to as a metalloid.

The present invention provides a process for producing silicon comprising reacting silica with a reducing gas comprising carbon monoxide, wherein the reducing gas does not contain elemental carbon. It is important that substantially no elemental carbon be present in the reducing gas, as, under the reaction conditions, carbon could react with the silicon to produce silicon carbide, which would contaminate the silicon. Thus the level of elemental carbon in the reducing gas may be kept below about 10 ppm, or less than about 5, 2, 1, 0.5, 0.2, 0.1, 0.05, 0.02 or 0.01 ppm on a mol basis relative to carbon monoxide, depending on the desired level of purity of the silicon produced by the process.

The reaction of the silica with the reducing gas may entail reduction of the silica with carbon monoxide in the reducing gas. It may or may not also entail reduction of the silica with some other component (e.g. reducing component) of the reducing gas. The carbon monoxide content of the reducing gas may be any desired non-zero value, for example between about 1 and about 100% on a weight, volume or mole basis, or between about 10 and 100, 25 and 100, 50 and 100 or 80 and 100, e.g. about 1, 5, 10, 15, 20, 25, 30, 35, 40, 45, 50, 55, 60, 65, 70, 75, 80, 85, 90, 95, 99, 99.5, 99.9 or 100%. The reducing gas may also comprise one or more other gases, preferably non-oxidising gases, optionally reducing gases and/or inert gases. The other gas(es) may for example be nitrogen, carbon dioxide, helium, neon, argon, etc or a mixture of any two or more of these gases. In some embodiments, the reducing gas does not contain hydrogen. The reducing gas may be substantially free (e.g. greater than about 95, 96, 97, 98, 99, 99.5 or 99.9% free) of environmental pollutants other than carbon dioxide and carbon monoxide. In some embodiments the reducing gas consists only of carbon dioxide and carbon monoxide. In other embodiments the reducing gas consists only of carbon dioxide, carbon monoxide and a carrier gas. The carrier gas may be for example nitrogen, helium, neon or argon.

The process may also comprise the step of generating the carbon monoxide by reaction of elemental carbon with oxygen. In this case, the ratio of oxygen to carbon may be such that no elemental carbon is produced. In these embodiments, the ratio of oxygen to carbon should be such that all of the oxygen is consumed. The ratio may be between about 2:1 and about 1:1 on a molar basis, or between about 2:1 and 1.5:1, 2:1 and 1.8:1, 1.5:1 and 1:1, 1.3:1 and 1:1, 1.9:1 and 1.1:1, 1.9:1 and 1.5:1, 1.5:1 and 1.1:1 or 1.8:1 and 1.3:1, e.g. about 1.1:1, 1.2:1, 1.3:1, 1.4:1, 1.5:1, 1.6:1, 1.7:1, 1.8:1, 1.9:1 or 2:1. Further, in these embodiments, the carbon used to generate the carbon monoxide should be of a suitable particle size as to enable rapid, preferably complete, reaction to carbon monoxide and optionally also carbon dioxide. The mean, or maximum, particle size of the carbon may be between about 10 microns and about 5 mm, or between about 1 microns and 1 mm, 10 and 500 microns, 10 and 100 microns, 10 and 50 microns 50 microns and 5 mm, 100 microns and 5 mm, 500 microns and 5 mm, 1 and 5 mm, 100 and 1000 microns, 100 and 500 microns or 500 and 1000 microns, e.g. about 10, 20, 30, 40, 50, 60, 70, 80, 90, 100, 150, 200, 250, 300, 350, 400, 450, 500, 550, 600, 650, 700, 750, 800, 850, 900 or 950 microns, or about 1, 1.5, 2, 2.5, 3, 3.5, 4, 4.5 or 5 mm, or may in some circumstances be greater than 5 mm.

The process may comprise the additional step of converting the carbon to a suitable particle size prior to generating the carbon monoxide. This may comprise grinding, pelletizing or some other suitable process. The carbon may be high purity carbon. It may be at least about 99% pure, or at least about 99.5, 99.9, 99.95, 99.99, 99.995 or 99.999% pure, or 99.5 to 100, 99.9 to 100, 99.95 to 100, 99.99 to 100, 99.995 to 100, 99.999 to 100, 99.5 to 99.999, 99.9 to 99.999, 99.95 to 99.999, 99.99 to 99.999 or 99.995 to 99.999% pure, e.g. about 99, 99.1, 99.2, 99.3, 99.4, 99.5, 99.6, 99.7, 99.8, 99.9, 99.95, 99.99, 99.995, 99.999, 99.9995, 99.9999 or 100% pure.

The carbon feed to the oxidation chamber will commonly in preferred embodiments contain some entrained gas. This may be air, or may be oxygen, carbon dioxide or other gas which is used to blanket the carbon in the carbon storage bin. The gas in the carbon storage bin is typically in preferred embodiments sufficiently pure that it does not introduce impurities into the product silicon.

The reaction product of the elemental carbon with the oxygen in preferred embodiments, comprises carbon monoxide optionally together with carbon dioxide. Under some conditions, it may also comprise some residual elemental carbon. In this case, the process may comprise removing elemental carbon from the reducing gas before the step of reacting the silica therewith. This may comprise filtering, microfiltering, centrifuging, settling or some other suitable process. The apparatus for removing the elemental carbon should be capable of withstanding the temperature of the reducing gas. It may for example comprise a sintered metal or ceramic (e.g. metal oxide) frit or some other high temperature filter device. Following the reaction of the carbon and oxygen to produce the carbon monoxide, the resulting gas may be blended with a diluent gas to generate the reducing gas. The diluent gas in the preferred embodiments should not comprise an oxidising gas, and may comprise a reducing gas. Suitable diluent gases for the preferred embodiments include nitrogen, carbon dioxide, helium, neon, argon etc. or mixtures of these. The diluent gas may be blended with the reaction product of the carbon and the oxygen in a ratio of between about 1 and about 90% diluent gas to resulting reducing gas. The ratio may be between about 1 and 50, 1 and 20, 1 and 10, 10 and 90, 50 and 90, 10 and 50 or 20 and 50%, e.g. about 1, 5, 10, 20, 30, 40, 50, 60, 70, 80 or 90% by volume. Alternatively, carbon monoxide may be provided from a container thereof, e.g. a commercial gas cylinder, and optionally blended with a diluent gas to produce the reducing gas. The nature and proportion of the diluent gas may be as described above. The carbon monoxide from the container may be used directly as the reducing gas, without addition of a diluent gas.

In preferred embodiments, the conditions of reaction of the carbon and oxygen to produce carbon monoxide should be such that violent combustion or explosion does not occur. They may be such that controlled oxidation of the carbon occurs. The oxidation may be a combustion, preferably a controlled combustion. Conditions that should be adjusted to achieve this aim may include temperature, pressure, ratio (quantity or flow rate) of carbon to oxygen, particle size of the carbon, presence and quantity or flow rate of a diluent gas, oxidation chamber design etc.

The reaction of the silica with the reducing gas generates silicon, and in preferred embodiments converts the reducing gas to an exhaust gas. Thus in this case the reaction represents a reduction of silica to silicon, and represents an oxidation of the reducing gas, in particular of carbon monoxide in the reducing gas to carbon dioxide in the exhaust gas. The exhaust gas preferably comprises carbon dioxide, and may also comprise carbon monoxide that has not been reacted with the silica. The carbon monoxide content of the exhaust gas will depend on the carbon monoxide content of the reducing gas, the ratio of reducing gas flow rate to the input rate of silica into the reactor, the conditions (temperature, pressure etc) within the reactor and other factors. It may be between about 1 and about 90%, or between about 1 and 80, 1 and 70, 1 and 60, 1 and 50, 1 and 20, 1 and 10, 10 and 90, 50 and 90, 10 and 50 or 20 and 50%, e.g. about 1, 2, 3, 4, 5, 10, 15, 20, 25, 30, 35, 40, 45, 50, 55, 60, 65, 70, 75, 80, 85 or 90% by volume.

Exhaust gas from the process may be used to preheat a raw material for the process prior to use thereof in the process. The preheating by the exhaust gas may be sufficient to raise the raw material to the desired temperature for entry into the process, or may be to a temperature below that. In the latter eventuality, additional heating, e.g. electrical heating, may be used to bring the raw material to the desired temperature. The exhaust gas from the process may be oxidised, e.g. burned, so as to convert substantially all of the carbon monoxide therein to carbon dioxide, thereby producing oxidised exhaust gas. The oxidised exhaust gas may be suitable for release to the atmosphere, i.e. it may meet environmental standards for carbon monoxide content. The carbon monoxide content of the oxidised exhaust gas may be below a toxic level. The carbon monoxide content of the oxidised exhaust gas may be less than about 100 ppm or less than about 50, 20 or 10 ppm, e.g. about 10, 20, 30, 40, 50, 60, 70, 80, 90 or 100 ppm.

The oxidised exhaust gas may be used to at least partially preheat one or more of the raw materials for the process prior to use thereof in the process.

The use of the exhaust gas and/or the oxidised exhaust gas to preheat raw materials in preferred embodiments reduces the amount of energy that needs to be inputted to the system in order to bring the raw materials to an appropriate reaction temperature either for production of carbon monoxide or for reduction of silica.

The step of reacting the silica with carbon monoxide may be conducted within a heated reaction chamber. The temperature of the heated reaction chamber may be controlled. It may be controlled to a temperature above the melting point of silicon (1683K, 1419° C.). The temperature should not be sufficiently high that the silicon vaporizes. The boiling point of silicon is 3173K (2900° C.). The temperature should be sufficient for reduction of silica by carbon monoxide to produce silicon. The temperature for reduction of silica may be for example between about 1400 and about 2300° C., or between about 1400 and 2000, 1400 and 1700, 1400 and 1500, 1500 and 2300, 2000 and 2300, 1500 and 2200, 1500 and 2000 or 1500 and 1800° C., e.g. about 1400, 1410, 1420, 1430, 1440, 1450, 1460, 1470, 1480, 1490, 1500, 1550, 1600, 1650, 1700, 1750, 1800, 1850, 1900, 1950, 2000, 2050, 2100, 2150, 2200, 2250 or 2300° C. Reduction of silicon is commonly conducted at about 1 atmosphere pressure, or at ambient pressure, but in some cases may be at some other pressure, for example between about 0.5 and 10 atmospheres, or between about 0.5 and 5, 0.5 and 2, 0.5 and 1, 1 and 10, 2 and 10, 5 and 10, 1 and 5 or 1 and 2 atmospheres, e.g. about 0.5, 0.6, 0.7, 0.8, 0.9, 1.1, 1.2, 1.3, 1.4, 1.5, 2, 2.5, 3, 3.5, 4, 4.5, 5, 6, 7, 8, 9 or 10 atmospheres, or some other pressure.

The flow rate of the reducing gas into the reaction chamber should be sufficient to completely reduce the silica to silicon. The reducing gas may be used in an amount (or at a flow rate) such that the molar reaction ratio of reducing components (carbon monoxide and any other reducing components of the reducing gas) over the silica is at least about 1.1, or at least about 1.2, 1.3, 1.4, 1.5, 2, 2.5, 3, 3.5, 4, 4.5, 5, 6, 7, 8, 9 or 10, or of between about 1.1 and about 10, or between about 1.1 and 5, 1.1 and 2, 1.5 and 10, 2 and 10, 3 and 10, 4 and 10, 5 and 10, 1.5 and 5 or 2 and 5, e.g. about 1.1, 1.2, 1.3, 1.4, 1.5, 1.6, 1.7, 1.8, 1.9, 2, 2.5, 3, 3.5, 4, 4.5, 5, 6, 7, 8, 9 or 10, or may in some circumstances be more than 10 or may be between 1 and 1.1. In determining the molar reaction ratio referred to above, it is necessary to account for the oxygen content of silica. Thus silica (SiO₂) contains two moles of oxygen per mole of silica. Thus for carbon monoxide as the reducing component of the reducing gas, the actual molar ratio between silica and the reducing component will be double the molar reaction ratio (to account for the two moles of oxygen per mole silica), so that a molar reaction ratio of 2 would represent a molar ratio of 4. This is because one atom of carbon monoxide requires one atom of oxygen to produce one mole of carbon dioxide. This can be shown in the case of silica as follows:

SiO₂+2CO→Si+2CO₂

The silicon may be degassed before it is allowed to solidify. The process of degassing may comprise applying an at least partial vacuum to the molten silicon. The at least partial vacuum may have an absolute pressure of less than about 500 mbar, or less than about 400, 300, 200, 100, 50, 20, 10, 5, 2 or 1 mbar, or of about 1, 2, 3, 4, 5, 6, 7, 9, 10, 20, 30, 40, 50, 60, 70, 80, 90, 100, 150, 200, 250, 300, 350, 400, 450 or 500 mbar. The degassing may comprise pumping the molten silicon, for example to remove it from the reactor, wherein the pump used for pumping is of a type that applies an at least partial vacuum to the liquid being pumped.

The present invention is particularly suited to the production of high purity silicon metal, for example for use in the semiconductor industry. In order to achieve this, it is necessary to use high purity reagents. In particular it is necessary that the silica be high purity. Copending application entitled “Purification of silica” PCT/EP2007/064383 provides a process for achieving this by converting the silica to a hydrolysable silicon species, e.g. silicon tetrafluoride gas, purifying the hydrolysable silicon species, and hydrolysing the purified hydrolysable silicon species to produce purified silica. The silica used in the process may be at least about 99.9% pure by weight, or may be at least 99.95, 99.99, 99.995 or 99.999% pure, and may be about 99.9, 99.91, 99.92, 99.93, 99.94, 99.95, 99.96, 99.97, 99.98, 99.99, 99.991, 99.992, 99.993, 99.994, 99.995, 99.996, 99.997, 99.998, 99.999, 99.9995 or 99.9999% pure. Additionally the conditions of reduction of the silica to silicon (temperature, CO concentration of the reducing gas, flow rate of the reducing gas, input rate of silica, particle size of the silica etc.) should be sufficient to ensure complete reduction of the silica to silicon.

Thus a suitable process for producing high purity silica for use in the present invention may comprise:
a) converting the silica into silicon tetrafluoride;
b) purifying the silicon tetrafluoride; and
c) hydrolysing the silicon tetrafluoride to produce purified silica, optionally at a temperature at which fluorosilicic acid is unstable.

Step a) may comprise reacting the silica with a mixture of hydrofluoric acid and fluorosilicic acid so as to convert it into silicon tetrafluoride. Step b) may comprise contacting the silicon tetrafluoride with a purifying agent. The process may be conducted in a plurality of steps in a counter-current manner. The purifying agent may comprise fluorosilicic acid.

The method may additionally comprise:
d) hydrolysing a portion of the silicon tetrafluoride from step b) to produce fluorosilicic acid and silica, and using the fluorosilicic acid in step b). The silica from steps c) and d) may be combined to provide the purified silica product.

Impurities may be removed from the purifying agent following the step of contacting the silicon tetrafluoride with the purifying agent. The purifying agent may comprise fluorosilicic acid and, following the step of contacting the silicon tetrafluoride with the fluorosilicic acid, the fluorosilicic acid may be converted into hydrogen fluoride and silicon tetrafluoride, whereby the hydrogen fluoride is used in step a). The silicon tetrafluoride may be used either to produce fluorosilicic acid for use in step a) or to supplement the hydrolysable silicon species produced in step a) or both. Step c) preferably uses high purity steam.

The method may additionally comprising one or both of the steps of:
e) washing the purified silica; and
f) drying the purified silica.

In step c), purified silica may be added to a high temperature hydrolyser in which step c) is conducted. The silica may be dried before step a) of the method.

In an embodiment of the method for producing purified silica for use in the present invention therefore:
i) step a) may comprise the use of a mixture of hydrofluoric acid and fluorosilicic acid;
ii) step b) may comprise contacting the silicon tetrafluoride with fluorosilicic acid;
iii) step c) may comprise hydrolysing a first portion of the silicon tetrafluoride from step b) using steam to produce purified silica; and
iv) the method additionally may comprise:
   hydrolysing a second portion of the silicon tetrafluoride from step b) to produce fluorosilicic acid and purified silica, the fluorosilicic acid being used in step b);
   and
   converting fluorosilicic acid from step b) into hydrogen fluoride and silicon tetrafluoride and drying the hydrogen fluoride and silicon tetrafluoride, whereby the hydrogen fluoride is used to generate the hydrofluoric acid used in step a) and the silicon tetrafluoride is used either to produce fluorosilicic acid for use in step a) or to supplement the silicon tetrafluoride produced in step a) or both.

The particle size of the silica used in preferred embodiments of the present invention is commonly in the range of about 10 to about 2000 microns in diameter. Commonly silica particles are not spherical. Thus in this context, “diameter” may refer to a maximum cross-particle dimension, or to a minimum cross-particle dimension, or to a mean cross-particle dimension or to a hydrodynamic diameter. The diameter may be between about 10 and about 2000 microns, or between about 10 and 1000, 10 and 500, and 200, 10 and 100, 10 and 50, 10 and 20, 50 and 2000, 100 and 2000, 500 and 2000, 1000 and 2000, 1500 and 2000, 50 and 1000, 50 and 500, 50 and 200, 100 and 1000, 100 and 500 or 500 and 1000 microns, e.g. about 10, 20, 30, 40, 50, 60, 70, 80, 90, 100, 150, 200, 250, 300, 350, 400, 450, 500, 600, 700, 800, 900, 1000, 1100, 1200, 1300, 1400, 1500, 1600, 1700, 1800, 1900 or 2000 microns, or may be greater than about 2000 microns. The diameter described here may represent a mean (number average or weight average) diameter or a maximum diameter.

The silica feed to the reaction chamber will in preferred embodiments commonly contain some entrained gas, which will be the gas used to blanket the silica in the silica storage bin. It is preferable that this gas is a non-oxidising gas, as the presence of an oxidising gas would consume extra reducing gas during the reduction of the silica. Thus the silica storage bin may be blanketed with a non-oxidising, optionally reducing, gas, e.g. nitrogen, carbon dioxide, carbon monoxide, argon, helium or some combination of these. If the silica is produced on site and used as produced rather than stored, any of the above non-oxidising, optionally reducing, gases, may be used to convey the silica to the reaction chamber.

The present invention also provides silicon produced by the process of the invention. The silicon may have a purity of at least about 99.9% by weight. The purity may be at least about 99.9% pure by weight, or may be at least 99.95, 99.99, 99.995 or 99.999% pure, and may be about 99.9, 99.91, 99.92, 99.93, 99.94, 99.95, 99.96, 99.97, 99.98, 99.99, 99.991, 99.992, 99.993, 99.994, 99.995, 99.996, 99.997, 99.998, 99.999, 99.9995 or 99.9999%. It may be of sufficiently high purity for use in the semiconductor industry. In order to achieve this purity, it is not only necessary to ensure that the silica is of suitably high purity, but also that the reactor for producing the silicon is made from materials that do not contaminate the silicon once produced. These materials may include metals, e.g. steel, stainless steel, titanium etc. that can not contaminate the silicon produced by the reactor. The materials may be pre-treated, e.g. washed, heated etc. to remove or reduce potential contaminants.

The present invention also in some aspects, provides a reactor suitable for conducting the process of the invention. The reactor preferably comprises a carbon oxidation chamber, and a reaction chamber in communication with the carbon oxidation chamber. The reaction chamber is fitted with a temperature controller for controlling the temperature inside the reaction chamber, and has a silica inlet port, and a silicon outlet port.

The carbon oxidation chamber comprises an inlet port for admitting carbon and/or oxygen, and may have separate inlet ports for carbon and oxygen. It may also comprise an inlet port, or other facility, for admitting a diluent gas to the carbon oxidation chamber. Alternatively the inlet port for the diluent gas, if present, may be disposed so that the diluent gas can be combined with the oxidation product obtained from the carbon and the oxygen in the carbon oxidation chamber. The carbon oxidation chamber may be heated to facilitate conversion of carbon and silica therein to carbon monoxide. Thus the reactor may comprise a heater for heating the carbon oxidation chamber. It may comprise a controller for controlling the temperature of the carbon oxidation chamber. In some embodiments, the carbon oxidation chamber at least partially surrounds the reaction chamber. In that configuration, heat generated in the oxidation chamber by partial oxidation of carbon to carbon monoxide may be used to heat the reaction chamber, optionally by means of an intervening heat storage material such as graphite. An advantage of graphite as a heat storage material is that it has a high melting point, and has a high heat capacity and increasing heat capacity with increasing temperature. It will be understood that other high heat capacity materials may also be used. It is preferred that the outside of the oxidation chamber be well insulated to minimise loss of heat by radiation. This also improves the safety of the reactor. A suitable preferred configuration involves an oxidation chamber having an annular cross section surrounding a reaction chamber in the core of the annular shape. Thus the oxidation chamber may be a cylinder having a hollow core containing the reaction chamber. It will be understood that the cross section of the oxidation chamber may have a square, rectangular, pentagonal, hexagonal etc. shape, having a core region for the reaction chamber.

The temperature controller for controlling the temperature of the carbon oxidation chamber may be the same as that for controlling the temperature inside the reaction chamber. The reaction chamber may be located within, or partially within, a heater block. The carbon oxidation chamber may be located within, or partially within, a heater block, which may be the same as or different to the heater block within which the reaction chamber is located. Thus in an embodiment, both the reaction chamber and the carbon oxidation chamber are located within a heater block. The heater block may have a temperature controller for controlling the temperature of the heater block, and thereby for controlling the temperature within the reaction chamber and within the carbon oxidation chamber. The temperature of the heater block may be controlled by a heater block controller, which may for example comprise a thermostat, an electrical heating element, a non-electrical heating device and/or other components. The heater block may conveniently comprise carbon, e.g. graphite, as a heat storage medium.

The reactor may comprise a silica feed system for providing silica to the reaction chamber. The silica feed system may communicate with the silica inlet port of the reaction chamber. The silica feed system may comprise a silica storage bin, or a silica generator, for example a high purity silica generator or a silica purifier. A suitable high purity silica generator is described in a copending application “Purification of silica” PCT/EP2007/064383. The silica feed system may optionally comprise a particle size reducer (e.g. a communicator, a crusher, a grinder etc) for reducing the particle size of the silica to a suitable size to act as a feed for the process. The silica feed system may also comprise a silica preheater. Energy for the preheater may be provided by hot exhaust gas from the reaction chamber or hot oxidised exhaust gas from the exhaust gas oxidation chamber, or both. The silica feed system may also comprise one or more suitable conveyors if required, for transporting the silica from the silica source to the silica preheater and from the silica preheater to the reaction chamber. The conveyors may comprise suitable pipes, tubes and conveying means. Conveying means may comprise conveyor belts, screw conveyors and/or other suitable means.

The silicon outlet port of the reaction chamber may communicate with a silicon collection chamber for collecting the silicon that is produced in the reaction chamber. Conveniently the silicon outlet port is located at or near the bottom of the reaction chamber, and the silicon collection chamber is located below the silicon outlet port, so that molten silicon produced in the reaction chamber can pass under gravity through the silicon outlet port to the silicon collection chamber. The silicon collection chamber may be maintained at a temperature at or above the melting point of silicon, so as to maintain the silicon in the molten or liquid state. It may be fitted with a heater and/or suitable insulation for maintaining it at that temperature.

The reactor may also comprise a degasser for degassing the silicon after it has left the reaction chamber. The degasser may be fitted to the silicon collection chamber, so that the silicon is degassed while in the liquid state. Conveniently, the degasser may comprise a pump which reduces the pressure on the liquid silicon in the process of transferring it from the silicon collection chamber, for example to a solidification apparatus for converting the degassed molten silicon to solid silicon.

The reactor may also comprise a silica preheater for preheating the silica prior to the silica entering the reaction chamber, and/or at least one preheater for preheating either the carbon or the oxygen or both. The, or either or both, preheater(s) may comprise a heat exchanger for transferring heat from the exhaust gas and/or the oxidised exhaust gas to the silica and/or to the carbon and/or to the oxygen. The reactor may comprise suitable pipework for passing exhaust gas from the reaction chamber, or oxidised exhaust gas obtained by oxidation of the exhaust gas, to at least one of these preheaters. The preheater for preheating the oxygen may be capable of heating the oxygen to a suitable temperature for oxidation of carbon to carbon monoxide, or to a temperature below the oxidation temperature for carbon. It may heat the oxygen to a temperature about 10, 20, 30, 40, 50, 60, 70, 80, 90, 100 or more than about 100° C. below the oxidation temperature for carbon. Similarly the preheater for preheating the carbon may be capable of heating the carbon to a suitable temperature for oxidation of carbon to carbon monoxide, or to a temperature below the oxidation temperature for carbon. It may heat the carbon to a temperature about 10, 20, 30, 40, 50, 60, 70, 80, 90, 100 or more than about 100° C. below the oxidation temperature for carbon. The preheater for preheating the silica may be capable of preheating the silica to a temperature of about that required for reaction of the silica with carbon monoxide to produce the silicon, or to a temperature about 10, 20, 30, 40, 50, 60, 70, 80, 90, 100 or more than about 100° C. below that temperature.

An exhaust gas oxidation chamber may be provided for oxidising carbon monoxide in exhaust gas from the reaction chamber to carbon dioxide in order to generate oxidised exhaust gas. Flow controllers may also be provided for controlling the flow of one or more of the carbon, the oxygen and the silica. A heat storage unit may be provided, which communicates thermally with the reaction chamber.

By using silicon dioxide and carbon both of a very high degree of purity according to preferred embodiments of this invention, it is possible by direct reduction at about the melting temperature of silicon to produce silicon metal with a comparably high degree of purity.

Accordingly, a reactor for producing silica according to the present invention may additionally comprise a system for purifying silica according to copending application entitled “Purification of silica” PCT/EP2007/064383. Thus it may comprise a system for purifying silica comprising:
a) a reactor for converting the silica into silicon tetrafluoride;
b) a first purifier for purifying the silicon tetrafluoride using a purifying agent; and
c) a hydrolyser (e.g. a high temperature hydrolyser) for hydrolysing the silicon tetrafluoride to produce purified silica, optionally at a temperature at which fluorosilicic acid is unstable.

The system may additionally comprise:
d) a low temperature hydrolyser for hydrolysing a portion of the purified hydrolysable silicon species from the first purifier to produce the purifying agent and silica; and
e) a diverter for diverting the portion of the purified hydrolysable silicon species to the low temperature hydrolyser.

The first purifier may be a multistage countercurrent purifier. The system may also comprise a second purifier, e.g. a distillation apparatus, for removing impurities from the purifying agent. The second purifier may also comprise a water remover. A purifier recycle system may also be provided for passing purified output from the second purifier to the reactor. The system may additionally comprise a high purity steam generator for generating high purity steam, the high purity steam generator communicating with the high temperature hydrolyser for providing high purity steam to the high temperature hydrolyser. It may further comprise a purifying agent feed system for passing the purifying agent from the second hydrolyser to the first purifier.

The system may additionally comprise one or both of:
d) a washer for washing the purified silica; and
e) a dryer for drying the purified silica.

The high temperature hydrolyser may comprise a silica inlet port. A predryer may be provided for predrying the silica before the silica enters the reactor. The system may additionally comprise:

a low temperature hydrolyser for hydrolysing a second portion of the purified silicon tetrafluoride from the first purifier to produce fluorosilicic acid and silica;

a diverter for diverting the portion of the purified silicon tetrafluoride to the low temperature hydrolyser;

a distillation apparatus for removing impurities from the fluorosilicic acid from the first purifier and for converting the fluorosilicic acid to hydrogen fluoride and silicon tetrafluoride;

a drier for removing water from the hydrogen fluoride and silicon tetrafluoride from the distillation apparatus; and

a purifier recycle system for passing hydrogen fluoride and silicon tetrafluoride from the drier to the reactor.

### Example

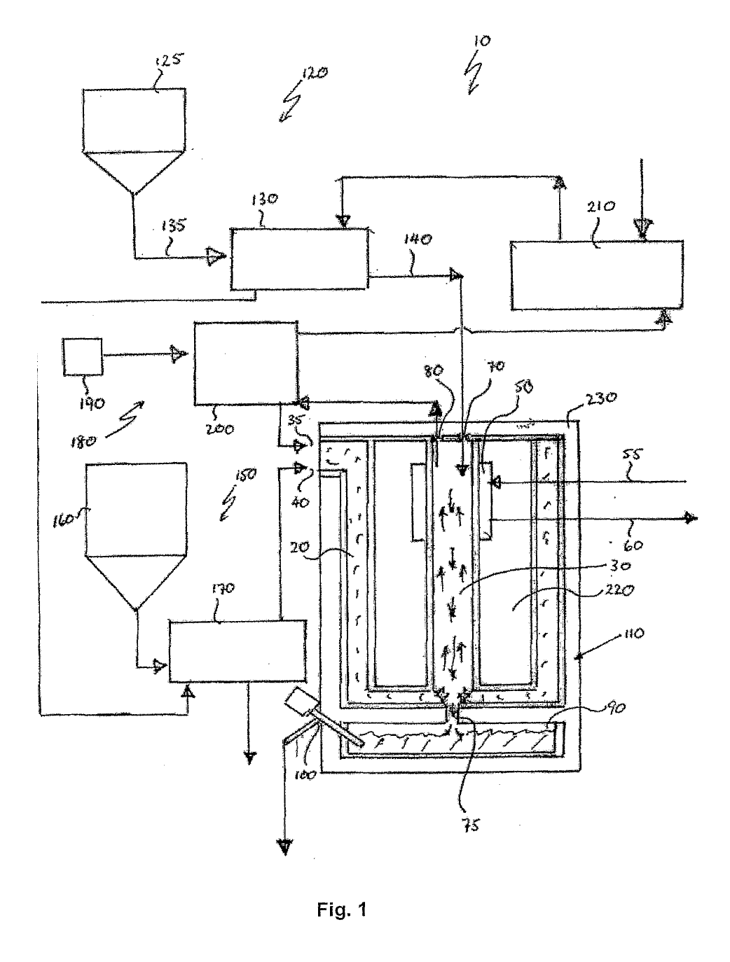

A suitable reactor for producing silicon according to a preferred embodiment of the present invention is shown in FIG. 1. In FIG. 1, reactor 10 comprises carbon oxidation chamber 20, which communicates with reaction chamber 30. Oxidation chamber 20 is fitted with oxygen inlet port 35 and carbon inlet port 40. Reaction chamber 30 is fitted with temperature controller 50, having inlet line 55 and outlet line 60 for passing a heat transfer material to and from controller 50 in order to control the temperature of reaction chamber 30. Reaction chamber 30 also has silica inlet port 70, silicon outlet port 75 and exhaust gas outlet port 80. Silicon outlet port 75 communicates with silicon collection chamber 90. Collection chamber 90 is fitted with pump 100, which can serve both to degas molten silicon after it has left reaction chamber 30 and also to pump it out of reactor 10 (i.e. out of collection chamber 90 of reactor 10). Oxidation chamber 20, reaction chamber 30 and collection chamber 90 are all located within heating block 110, conveniently a block of carbon, for maintaining the temperature in those chambers. Block 110 is temperature controlled by means of controller 50. Carbon is particularly suitable as a preferred material for use in heating block 110 due to its high thermal conductivity and increasing heat capacity with temperature.

Reactor 10 also comprises silica feed system 120. Feed system 120 comprises silica storage bin 125 and silica preheater 130, together with conveyors 135 and 140 for conveying silica from bin 125 to preheater 130 and from preheater 130 to inlet port 70 respectively. Conveyors 135 and 140 are conveniently screw type conveyors, which enable silica to be conveyed from bin 125 into reaction chamber 30 with minimal exposure to contaminants, e.g. from the atmosphere. Similarly, storage bin 125 is designed so as to avoid contamination of the high purity feed silica therein. In some embodiments of the invention, storage bin 125 may be replaced by an apparatus for generation of high purity silica, whereby the silica is supplied to feed system 120 continuously as it is produced.

Reactor 10 also comprises a carbon feed system 150, comprising a carbon storage bin 160, disposed to supply carbon to carbon preheater 170. Oxygen feed system 180 comprises oxygen source 190 disposed to supply oxygen to oxygen preheater 200. Oxygen source 190 may be an oxygen container, or may be an oxygen generator, e.g. a membrane based or chemical based oxygen generator.

Reactor 10 further comprises exhaust gas oxidation chamber 210 for oxidising carbon monoxide in exhaust gas from reaction chamber 30 to carbon dioxide in order to generate oxidised exhaust gas.

Aspects of an embodiment of the invention are as follows:

I Anthracite coal may be refined to extremely high levels of purity. Provided it is handled and stored in clean systems, it may be used in the reduction process of the present invention. This may be stored in carbon storage bin 160.

II It is possible to have available extremely high purity dry silicon crystals. As these crystals are abrasive, storage and handling must be carried out with care. The pure silicon dioxide is stored in silica storage bin 125. The silica may be generated using the method of copending application entitled “Purification of silica”.

III Silica preheater 130 may be lined with silicon carbide or some other suitable temperature resistant material. Preheater 130 may be heated by means of combustion of exhaust gases from reaction chamber 30, to pre-heat the pure silica for injection into reaction chamber 30.

IV Oxygen preheater 130 is a heat exchange unit designed to pre-heat the combustion oxygen needed. It may conveniently be heated by exhaust gases which exit reaction chamber 30.

V Carbon preheater 170 is a heat storage system lined with smooth silicon carbide or other heat resistant material and heated by the waste combustion heat from oxidation of the exhaust gas from reaction chamber 30. Preheater 170 is designed to pre-heat pure carbon material prior to its injection into oxidation chamber 20.

VI Oxidation chamber 20 is an important part of the system in which the balance between the pre-heated carbon and the pre-heated oxygen gas is controlled to ensure that there is insufficient oxygen to produce CO₂ and no free carbon in the combustion cycle. Oxidation chamber 20 surrounds reaction chamber 30, passing its heat to the heat storage material between the combustion chamber and the reactor chamber. Thus oxidation chamber 30 may be annular, or may have a similar shape but with a rectangular, square, pentagonal, hexagonal or similar cross-section.

VII Reaction chamber 30 is temperature controlled by the heat storage system to a temperature of about 1410° C. In reactor chamber 30 the reducing gas at temperature comprises CO. The CO reacts to remove O₂ from the SiO₂, creating CO₂ which leaves the silicon free in high purity to fall as a liquid into collection chamber 90 via outlet port 75.

VIII In order to control the temperature in reaction chamber 30 at the correct temperature for the reaction a graphite heat storage unit 220 is used. This unit is heated by the oxidation of the carbon by oxygen to CO in the oxidation chamber 20, and its heat is controlled accurately by temperature controller 50.

IX In order to retain the heat, outside surface 230 surrounding oxidation chamber 20 is heavily insulated.

X The silicon produced in the process is collected in collection chamber 90 below reaction chamber 30.

XI As there may be some CO or CO₂ present in the structure of the silicon, an intermediate pumping, and vacuum gas extraction 100 is employed to remove all gases.

XII As the process of the invention operates on the basis of pure high temperature carbon monoxide reacting with the silicon dioxide, an excess of carbon monoxide will be present in the CO₂ exhausting from reaction chamber 30. In the heat exchanger 210 additional air or oxygen is added that will react with the CO to form CO₂ and at the same time add heat to the oxidised exhaust gas, which may then be used for preheating the silica/carbon/oxygen used in the process.

XIII Temperature controller 50 is a heat controlled system thermally coupled to reaction chamber 30 and having available water cooling passing through lines 55 and 60 as required.

XIV In order to produce pure product from the process the inner lining of oxidation chamber 20, reaction chamber 30 and collection chamber 90 are lined with high quality surface silicon carbide, which has high heat transfer characteristics and must be constructed to bond to heat storage unit 220 to allow efficient heat transfer to occur.

The reactor of FIG. 1 may be operated as follows. Oxygen is supplied from source 190 to preheater 200, and is passed from there through inlet port 35 to oxidation chamber 20. High purity carbon in powdered or granular form is stored in bin 160, and passes from bin 160 via preheater 170 through inlet port 40 to oxidation chamber 20. Conveyors, e.g. screw conveyors, may be used to convey the carbon as described. Preheaters 170 and 200 heat the carbon and oxygen respectively to suitable temperatures to allow rapid reaction in chamber 20. In chamber 20, the carbon is partially oxidised to form a reducing gas, which consists mainly of carbon monoxide, although some carbon dioxide may also be present. The feed rates of oxygen and carbon into chamber 20 are preferably adjusted to ensure that the carbon is completely converted, so that no elemental carbon can pass to reaction chamber 30, and to also ensure that the reducing gas generated in chamber 20 by partial oxidation of the carbon contains no free oxygen. The oxidation reaction in chamber 20 provides heat energy, which is conveyed through heat storage unit 220 to heat reaction chamber 30. Also, the reducing gas produced in chamber 20 passes into the lower portion of reaction chamber 30.

High purity silica is stored in bin 125, protected from contaminants. It passes from there to silica preheater 130, which raises its temperature to facilitate its reduction. It then passes by means of conveyor 140 through inlet port 70 into the upper portion of reaction chamber 30. Thus in chamber 30, reducing gas passes upwards while silica moves downwards in a countercurrent manner relative to the reducing gas. As the silica passes down reaction chamber 30, it is reduced by the reducing gas to silicon. Reaction chamber 30 is preferably maintained at a temperature between the melting point of silica and the melting point of silicon. This may be achieved by the heat provided by the oxidation reaction in chamber 20 together with cooling, if necessary, provided by controller 50. Thus the silicon is formed as a liquid, which precipitates to the bottom of chamber 30 and flows through outlet port 75 into collection chamber 90. Pump 100 then pumps the liquid silicon to a storage location (note shown in FIG. 1), and in doing so degasses the liquid silicon, removing residual carbon monoxide and/or carbon dioxide. The silicon produced in this process is of high purity, and care should be taken to avoid downstream contamination of the product.

As the reducing gas reduces the silica to silicon, it is itself oxidised, generating carbon dioxide. Thus the exhaust gas which exits chamber 30 contains a mixture of carbon dioxide with unreacted carbon monoxide. This gas is at high temperature, and is passed to preheater 200, where a portion of its heat energy is transferred to the oxygen which is fed to oxidation chamber 20. The exhaust gas then passes to exhaust gas oxidation chamber 210, which is also fitted with an air or oxygen inlet. Thus, in chamber 210 the exhaust gas is oxidised, converting unreacted carbon monoxide into carbon dioxide. This generates extra heat energy, which heats the oxidised exhaust gas. The oxidised exhaust gas then passes to silica preheater 130, for heating the high purity silica fed to reaction chamber 30. The oxidised exhaust gas then passes to carbon preheater 170 where it is used to heat the carbon which is fed to oxidation chamber 20. The resulting oxidised exhaust gas has a very low level of carbon monoxide and is at a relatively moderate temperature, and is therefore suitable for venting to the atmosphere.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

1-20. (canceled)

21. A process for producing silicon comprising reacting silica with a reducing gas comprising carbon monoxide, wherein the reducing gas does not contain elemental carbon.

22. The process of claim 21 comprising generating the reducing gas by reaction of elemental carbon with oxygen.

23. The process of claim 21 wherein the silica is reacted with the reducing gas within a heated reaction chamber.

24. The process of claim 23 wherein the temperature of the heated reaction chamber is controlled.

25. The process of claim 21 wherein the silica is reacted with the reducing gas at a temperature above the melting point of silicon.

26. The process of claim 25 wherein the silicon is degassed before it is allowed to solidify.

27. The process of claim 21 wherein exhaust gas from the process is oxidised so as to convert substantially all carbon monoxide therein to carbon dioxide, thereby producing oxidised exhaust gas.

28. The process of claim 27 wherein the oxidised exhaust gas is used to preheat a raw material for the process.

29. The process of claim 21 wherein the silica is at least about 99.9% pure by weight.

30. Silicon produced by the process of claim 21.

31. A reactor for producing silicon comprising:
a carbon combustion chamber for reacting carbon with oxygen to generate a reducing gas comprising carbon monoxide, wherein the reducing gas contains no elemental carbon;
a reaction chamber for reacting the reducing gas containing no elemental carbon with silica, the reaction chamber communicating with the carbon combustion chamber;
a temperature controller for controlling the temperature of the reaction chamber;
a silica inlet port communicating with the reaction chamber for admitting the silica to the reaction chamber; and
a silicon outlet port communicating with the reaction chamber for allowing the silicon to leave the reaction chamber.

32. The reactor of claim 31 further comprising a degasser for degassing the silicon after it has left the reaction chamber.

33. The reactor of claim 31 further comprising a silica preheater for preheating the silica prior to the silica entering the reaction chamber.

34. The reactor of claim 31 further comprising at least one preheater for preheating either the carbon or the oxygen or both the carbon and oxygen.

35. The reactor of claim 33 comprising pipework for passing exhaust gas from the reaction chamber, or oxidised exhaust gas obtained by oxidation of the exhaust gas, or both, to at least one of the preheaters for preheating at least one of the carbon, the oxygen and the silica.

36. The reactor of claim 31 comprising an exhaust gas combustion chamber for oxidising carbon monoxide in exhaust gas from the reaction chamber to carbon dioxide in order to generate oxidised exhaust gas.

37. The reactor of claim 31 further comprising one or more flow controllers for controlling the flow of one or more of the carbon, the oxygen and the silica.

38. The reactor of claim 31 wherein the reaction chamber communicates thermally with a heat storage unit.

39. A process for producing silicon, the process comprising:
providing a reactor, the reactor comprising a carbon combustion chamber for reacting carbon with oxygen to generate a reducing gas comprising carbon monoxide, the reducing gas containing no elemental carbon;
a reaction chamber for reacting the reducing gas containing no elemental carbon with silica, the reaction chamber communicating with the carbon combustion chamber; a temperature controller for controlling the temperature of the reaction chamber;
a silica inlet port communicating with the reaction chamber for admitting the silica to the reaction chamber; and a silicon outlet port communicating with the reaction chamber for allowing the silicon to leave the reaction chamber;
supplying oxygen and carbon to the carbon combustion chamber;
reacting the carbon with the oxygen to generate a reducing gas comprising carbon monoxide, the reducing gas containing no elemental carbon;
supplying the reducing gas and the silica to the reaction chamber; and
reacting the reducing gas and the silica to produce the silicon and exhaust gas.

40. Use of a reactor according to claim 31 to produce silicon.
